(19) United States
(12) Patent Application Publication
(10) Pub. No.: US 2024/0170743 A1
(43) Pub. Date: May 23, 2024

(54) BATTERY CELL AND BATTERY DEVICE INCLUDING BATTERY CELL

(71) Applicant: SK ON CO., LTD., Seoul (KR)

(72) Inventors: John Cronin, Jericho, VT (US); Mi So RHO, Daejeon (KR); Soo Min PARK, Daejeon (KR); Hyung Ju PAIK, Daejeon (KR); Hae Ryong JEON, Daejeon (KR)

(21) Appl. No.: 18/360,811

(22) Filed: Jul. 28, 2023

Related U.S. Application Data
(60) Provisional application No. 63/427,678, filed on Nov. 23, 2022.

(51) Int. Cl. H01M 10/44; H01M 50/202; H01M 50/204; H01M 50/531

(52) U.S. Cl. CPC H01M 10/443; H01M 50/202; H01M 50/204; H01M 50/531; H01M 2200/106

(57) ABSTRACT

A battery cell and a battery device including the same are disclosed. In some implementations, the battery cell includes an electrode assembly including an electrode foil, an electrode terminal electrically connected to the electrode foil, and a positive temperature coefficient (PTC) fuse coupled to the electrode terminal, the PTC fuse including a PTC material. The PTC fuse blocks or limits current flow between the electrode terminal and the outside at a set temperature or higher.

### CROSS-REFERENCE TO RELATED APPLICATION(S)

This patent document claims the benefit of U.S. Provisional Patent Application No. 63/427,678 filed on Nov. 23, 2022, the disclosure of which is incorporated herein by reference in its entirety.

### TECHNICAL FIELD

The technology and implementations disclosed in this patent document generally relate to a battery cell capable of being charged with and discharged of electricity, and more particularly, to a battery cell capable of increasing safe operation and a battery device including the same.

### BACKGROUND

Battery cells may have issues with a temperature rise when excessive heat and pressure builds up inside a can (case) thereof. An increase in battery cell temperature may compromise the functional safety and reliability of battery cells.

In addition, when various events occur, such as when a battery cell reaches the end of a lifespan thereof, when a swelling phenomenon occurs in a battery cell, when an overcharge occurs in a battery cell, when a battery cell is exposed to heat, when a sharp object such as a nail penetrates the case of a battery cell, and when an external shock is applied to a battery cell, the temperature of the battery cell may increase, and a fire may accordingly occur. A flame or high-temperature gas ejected from a battery cell may cause chain ignition of other, adjacent battery cells accommodated in a battery device.

### SUMMARY

The disclosed technology can be implemented in some embodiments to provide a battery cell capable of blocking or limiting the flow of current flowing through the battery cell when the temperature of the battery cell increases.

In addition, the disclosed technology can be implemented in some embodiments to provide a battery cell capable of delaying or reducing thermal runaway in which flames are sequentially propagated from a battery cell having increased temperature to an adjacent battery cell, and a battery device including the same.

In some embodiments of the disclosed technology, a battery cell includes an electrode assembly including an electrode foil, an electrode terminal electrically connected to the electrode foil, and a positive temperature coefficient (PTC) fuse coupled to the electrode terminal, the PTC fuse including a PTC material. The PTC fuse may block or limit current flow between the electrode terminal and the outside at a set temperature or higher.

In embodiments, the PTC fuse may include a first portion including the PTC material, the first portion electrically connected to the electrode terminal.

In embodiments, the PTC fuse may further include a second portion and a third portion respectively disposed on both sides of the first portion, and the second portion and the third portion have electrical conductivity.

In embodiments, the PTC fuse may include a non-conductive layer surrounding a side surface of the first portion.

The battery cell according to one embodiment may further include a terminal connector coupled to the electrode terminal to supply current from the electrode terminal to the outside. The PTC fuse may be integrally coupled to the terminal connector.

In embodiments, the terminal connector may include an outbound connection region connecting the PTC fuse and an external circuit to each other, and the outbound connection region may have electrical conductivity.

In embodiments, the outbound connection region may be exposed to the outside of the electrode terminal.

In embodiments, the PTC fuse may have a diameter greater than that of the outbound connection region.

In embodiments, the terminal connector may further include a terminal connection region connecting the PTC fuse and the electrode terminal to each other, and the terminal connection region may have electrical conductivity.

In embodiments, the terminal connection region may be disposed to be recessed into the electrode terminal or disposed to be affixed to an external surface of the electrode terminal.

In embodiments, the terminal connection region may be threadedly coupled or weldedly coupled to the electrode terminal.

In embodiments, the terminal connector may include a screw thread formed on at least a portion of a side surface thereof.

In embodiments, at least one of the outbound connection region and the terminal connection region may include a PTC material.

In embodiments, the PTC fuse may be integrally coupled to the electrode terminal.

The battery cell according to one embodiment may further include a case accommodating the electrode assembly, and a cap plate covering the case. The electrode terminal may pass through the cap plate to be disposed on the inside and outside of the case.

In embodiments, the electrode terminal may include a first terminal body having at least a portion disposed on the outside of the case, and a second terminal body having at least a portion disposed on the inside of the case, the second terminal body electrically connecting the electrode foil and the first terminal body to each other, and the PTC fuse may be integrally coupled to at least one of the first terminal body and the second terminal body, or is disposed between the first terminal body and the second terminal body.

In embodiments, the electrode terminal may include a terminal body passing through the cap plate to be disposed on the outside of the case, and the PTC fuse may be integrally coupled to the terminal body.

In embodiments, the electrode terminal and the electrode foil may be connected to each other by a current collector.

In embodiments, the electrode terminal may include an anode terminal and a cathode terminal, and the PTC fuse may be disposed on at least one of the anode terminal and the cathode terminal.

In some embodiments of the disclosed technology, a battery device includes a plurality of battery cells, a housing accommodating the plurality of battery cells, and a controller connected to at least one of the plurality of battery cells to control at least one of the plurality of battery cells. The plurality of battery cells may include an electrode assembly including an electrode foil, an electrode terminal electrically connected to the electrode foil, and a positive temperature coefficient (PTC) fuse coupled to the electrode terminal, the PTC fuse including a PTC material. The PTC fuse may block or limit current flow between the electrode terminal and the outside at a set temperature or higher. The controller may control operation of at least one of the battery cells, when an output voltage, sensed from at least one of the plurality of battery cells, rapidly decreases in comparison to a set reference.

According to one embodiment, when the temperature of a battery cell increases, the current flow of the battery cell may be blocked or limited through a PTC fuse, thereby improving the stability of the battery cell. Also, the PTC fuse may operate according to an increase in the temperature of at least one of the plurality of battery cell, thereby being able to stably cope with an increase in temperature caused by other factors such as overheating and the like in addition to overcurrent.

According to one embodiment, an increase in the temperature of some battery cells may be sensed, such that the some battery cells having increased temperature may be controlled, thereby improving the stability of a battery device.

According to one embodiment, thermal runaway in which flames are sequentially propagated from a battery cell having increased temperature to an adjacent battery cell may be delayed or reduced.

### BRIEF DESCRIPTION OF DRAWINGS

Certain aspects, features, and advantages of the disclosed technology are illustrated by the following detailed description with reference to the accompanying drawings.

FIG. 1 is an exploded perspective view of a battery cell according to one embodiment.

FIGS. 2A, 2B, and 2C are views for illustrating a top cap assembly according to one embodiment.

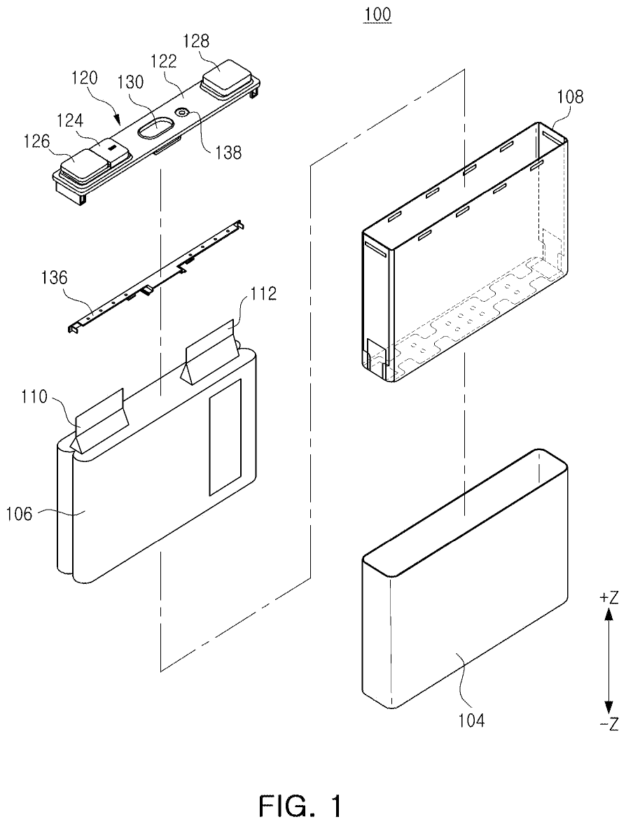

FIGS. 1A to 3F are a view for illustrating an assembly process of a top cap assembly and an electrode assembly according to one embodiment.

FIGS. 4A to 4F are a view for illustrating an assembly process of an electrode assembly, a jelly roll bag, and a can according to one embodiment.

FIG. 5A is a perspective view of an electrode assembly including an electrode foil, according to one embodiment.

FIG. 5B is a perspective view illustrating a connection between an electrode foil and an electrode terminal on a top cap assembly, according to one embodiment.

FIG. 6 is a schematic diagram illustrating the effects of thermal runaway, according to one embodiment.

FIGS. 7A and 7B are graphs illustrating a detection region of a PTC fuse, according to one embodiment. FIG. 7A is a graph illustrating a relationship between temperature and resistance in a positive temperature coefficient (PTC) material, and FIG. 7B is a graph illustrating an example of a resistance response of a PTC material to temperature.

FIG. 8 is a perspective view illustrating a structure in which a terminal connector is coupled to an electrode terminal of a battery cell, according to one embodiment.

FIG. 9A is a partially cut-away perspective view schematically illustrating a coupling portion between an electrode terminal and a terminal connector in FIG. 8.

FIG. 9B is a cross-sectional view of a PTC fuse taken along line I-I′ of FIG. 9A.

FIG. 9C is a cross-sectional view of a terminal connector taken along line I-I′ of FIG. 9A.

FIG. 10 is a cross-sectional view illustrating a modification of the terminal connector illustrated in FIG. 9C.

FIG. 11 is a cross-sectional view taken along line II-II′ of FIG. 8, according to one embodiment.

FIG. 12 is a cross-sectional view illustrating a modification of the battery cell illustrated in FIG. 11.

FIGS. 13A, 13B, and 13C are cross-sectional views illustrating a modification of the battery cell illustrated in FIG. 12.

FIGS. 14A and 14B illustrate a modification of a terminal connector. FIG. 14A is a perspective view, and FIG. 14B is a cross-sectional view taken along line III-III′ of FIG. 14A.

FIG. 15 is a cross-sectional view illustrating a state in which the terminal connector illustrated in FIG. 14A is installed.

FIGS. 16A and 16B illustrate another modification of a terminal connector. FIG. 16A is a perspective view, and

FIG. 16B is a cross-sectional view taken along line IV-IV′ of FIG. 16A.

FIG. 17 is a cross-sectional view illustrating a state in which the terminal connector illustrated in FIG. 16A is installed.

FIGS. 18 and 19 are cross-sectional views illustrating the arrangement of a PTC fuse, according to another embodiment.

FIG. 20 is a graph illustrating a change in output voltage of a battery cell based on a change in temperature.

FIG. 21 is a schematic diagram of a battery device, according to one embodiment.

### DETAILED DESCRIPTION

Embodiments of the present disclosure will be more fully described below with reference to the accompanying drawings, in which like symbols indicate like elements throughout the drawings, and embodiments are shown. However, embodiments of the claims may be implemented in many different forms and are not limited to the embodiments described herein. The examples given herein are non-limiting and only examples among other possible examples.

FIG. 1 is an exploded perspective view of a battery cell according to an embodiment.

Referring to FIG. 1, a battery cell 100 may be a prismatic cell. Prismatic cells are widely used in powertrains of electric vehicles. The prismatic cells may be stacked together in a rectangular shape, allowing more efficient use of space. Prismatic cells are generally rectangular and have a higher power density than cylindrical cells. Prismatic cells also provide better performance in cold weather and less damage from vibration. However, prismatic cells may be more expensive to manufacture than cylindrical cells. In addition, prismatic cells are less likely to fail due to vibration or movement. Prismatic cells may deliver more power than cylindrical battery cells due to spatial optimization of the rectangular shape thereof.

The prismatic battery cell 100 includes a rectangular can 104 that may be formed of steel, aluminum, aluminum alloy, plastic, or other metals having sufficient structural strength. The can 104 may be manufactured according to various different methods including deep draw or impact extrusion. The method for manufacturing the can 104 may be combined with wall ironing to achieve the final geometry, thickness and tolerances. The can 104 may be wrapped with cell cover tape.

A jelly roll 106 includes a stacked anode, cathode and separator. A jelly roll 106 type electrode assembly configured to have a structure of a long sheet type cathode and a long sheet type anode to which an active material is applied is wound. At the same time, the stacked-type electrode assembly has a structure in which a separator is disposed between a cathode and an anode or has a structure in which a plurality of cathodes and anodes having a predetermined size are sequentially stacked and a separator is disposed between each of the cathodes and the anode. The jelly roll-type electrode assembly is easy to manufacture and has high unit mass and energy density, compared to a sheet-type electrode assembly. In some batteries, one or more jelly rolls 106 are inserted into can 104. Each jelly roll (electrode assembly) 106 is inserted inside the can 104 while being accommodated in a polymer jelly roll bag 108 or wrapped in a jelly roll sealing tape.

Each jelly roll 106 includes a cathode foil 112 formed of aluminum. The aluminum foil is coated with the electrode slurry. A first operation of electrode manufacturing is a slurry mixing process in which an active raw material is combined with a binder, a solvent and an additive. This mixing process should be performed separately for anode and cathode slurries. Viscosity, density, solids content and other measurable properties of the slurry affect battery quality and electrode uniformity. For example, a slurry having a faster drying rate, a higher solids content, a lower rate capability, and a low viscosity is generated as a solvent content is higher. Thereafter, the cathode slurry is applied to an aluminum foil and dried. A slot die coater is a method of coating a foil in which a slurry is spread through slot gaps on the moving foil receiving tension over rollers. In some embodiments, this may be performed simultaneously on both sides of the foil. This production method enables high speed, while achieving precision in coating thickness. A drying process may be incorporated into a continuous coating. The drying process should achieve three objectives: diffusion of the binder, sedimentation of particles, and evaporation of the solvent. Air floatation is a method of drying the slurry on the foil. Uniformity of the electrode coating and drying process affects the safety, consistency and life cycle of the prismatic battery cell 100. The electrode should go through a calendering process in which electrode porosity and twist are controlled by compressing the coated electrode sheet to a uniform thickness and density.

Each jelly roll 106 includes an anode foil 110 formed of copper foil. The anode foil 110 is provided similarly to a cathode foil 112. Each jelly roll 106 may include a cathode connector (not shown) that makes an electrical connection between the inner end portion of the cathode foil 112 and the cathode terminal 128. Each jelly roll 106 may include an anode connector (not shown) that makes an electrical connection between the inner end portion of the anode foil 110 and an anode terminal 126. Each jelly roll 106 may include a cathode connector mask (e.g., a cathode connector mask 118 in FIG. 3C).

Each prismatic battery cell 100 may have a top cap assembly (upper cap assembly) 120 welded or otherwise bonded to the top of the can 104. The top cap assembly 120 may include a base plate 122 attached to the can 104. The base plate 122 isolates the inside and outside of the cell by welding with the can 104. The base plate 122 may serve as a rigid support structure for elements within the top cap assembly 120. The top cap assembly 120 may include a plurality of top insulators 124 to insulate the base plate 122. The top insulator 124 may prevent leakage of an electrolyte from the prismatic battery cell 100. Additionally, the top insulator 124 may isolate the can 104 from the cathode foil 112 and prevent penetration of moisture and gases from the outside of the cell. A portion of the top insulator 124 may protect a current interrupting device. The top cap assembly 120 includes a cathode terminal 128 electrically connecting the inside and outside of the prismatic battery cell 100. The top cap assembly 120 includes an anode terminal 126 electrically connecting the inside and outside of the prismatic battery cell 100.

The top cap assembly 120 may include a vent cover 130 allowing exhaust gases from the prismatic battery cell 100 to be discharged in a controlled direction and at a controlled pressure. The top cap assembly 120 may include a vent guard 132 protecting the vent cover 130 from the inside of the prismatic battery cell 100 in order to prevent the vent cover 130 from malfunctioning. The top cap assembly 120 may include an overcharge safety device 134 preventing an external current from being introduced using an internal gas pressure of the prismatic battery cell 100. The top insulator 124 may be multi-component. In some embodiments, side portions of the top insulator 124 may be mounted on the edges of the can 104 and the top cap assembly 120. Once the prismatic battery cell 100 is configured, an electrolyte solution may be injected through an electrolyte injection port. An electrolyte cap 138 may close or seal the injection port.

The battery cell 100 may include an insulator 136 located between the top cap assembly 120 and the can 104.

In this document, the electrode assembly of the battery cell 100 is described as the jelly roll 106, but the electrode assembly of the battery cell 100 is not limited to the jelly roll 106. For example, the jelly roll 106 may be replaced with a stack type electrode assembly or a Z-folding type electrode assembly. According to an embodiment, the jelly roll 106 described herein may refer to an electrode assembly.

In this document, the can 104 may be referred to as a case or housing.

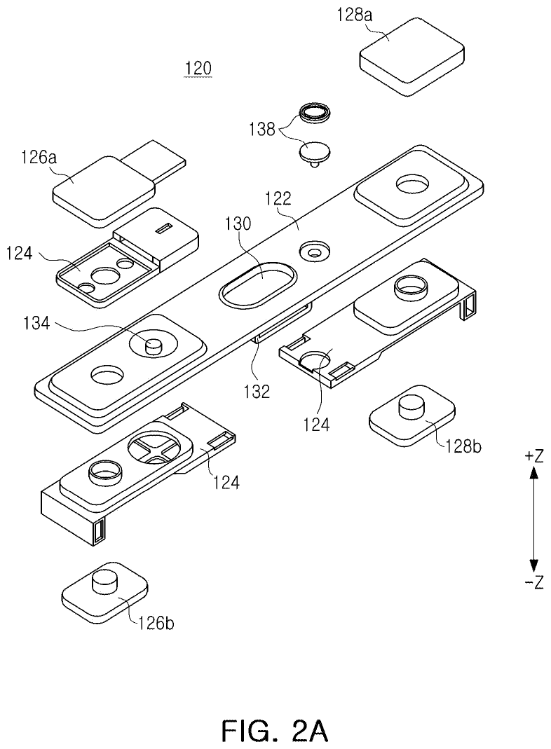

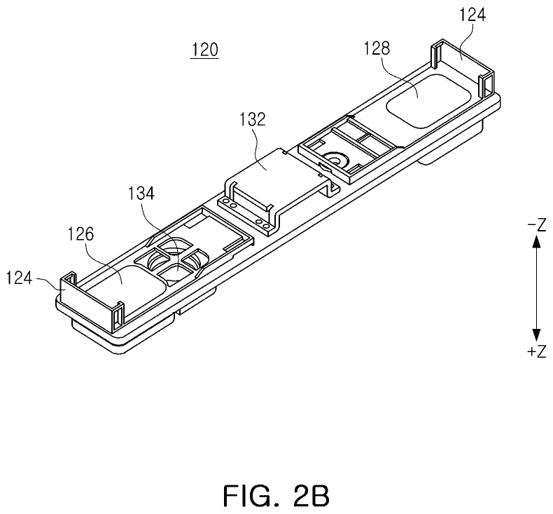

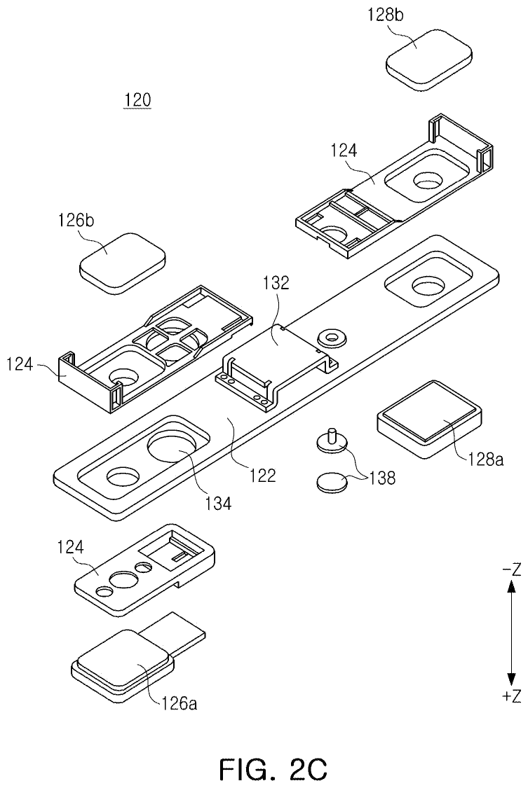

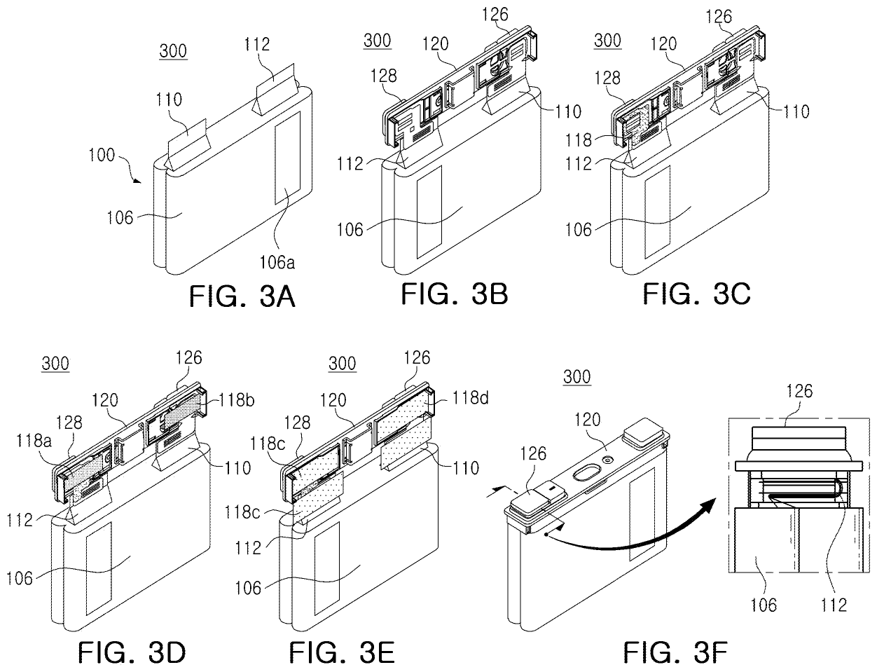

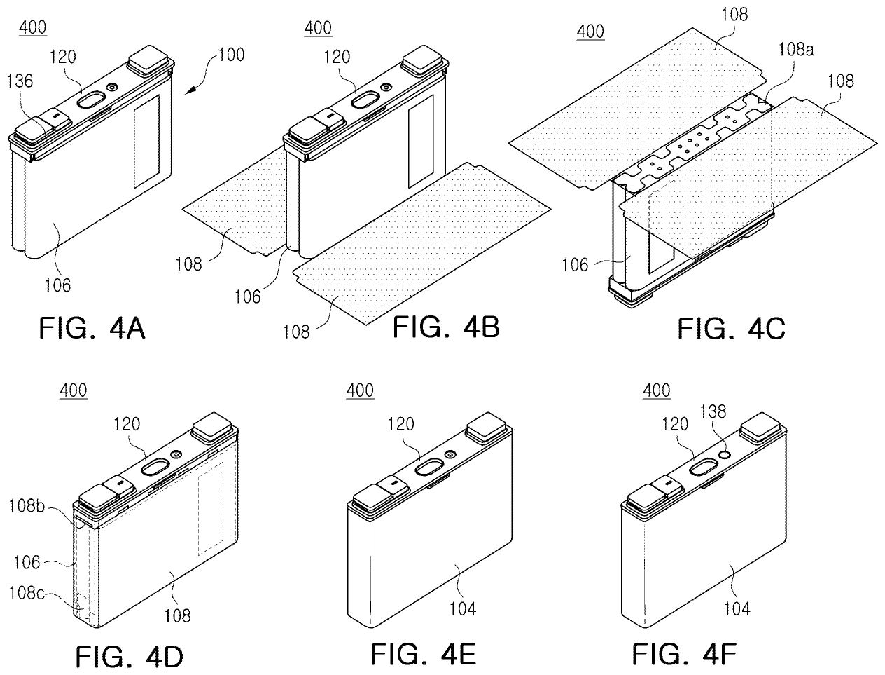

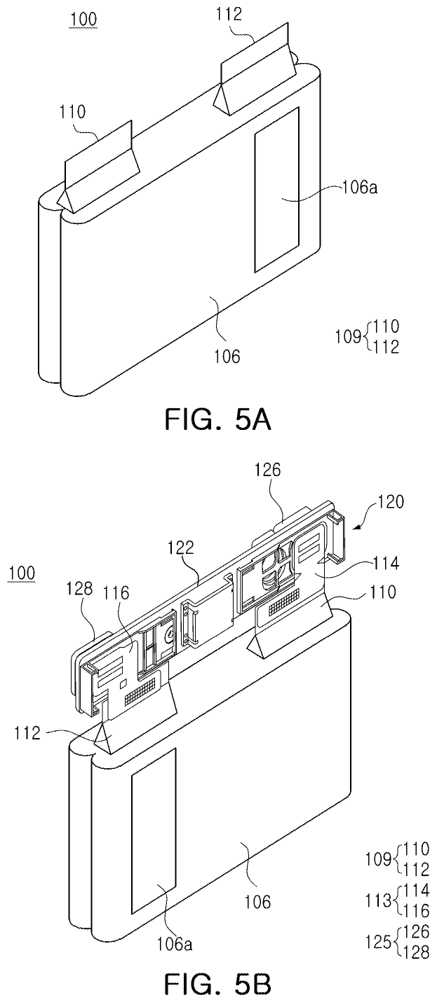

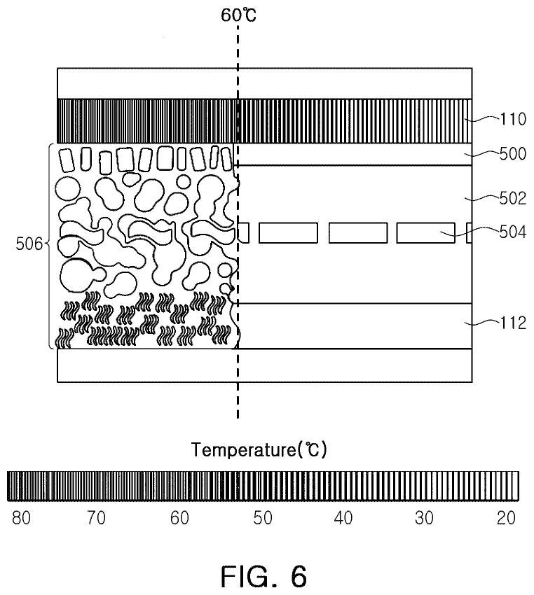

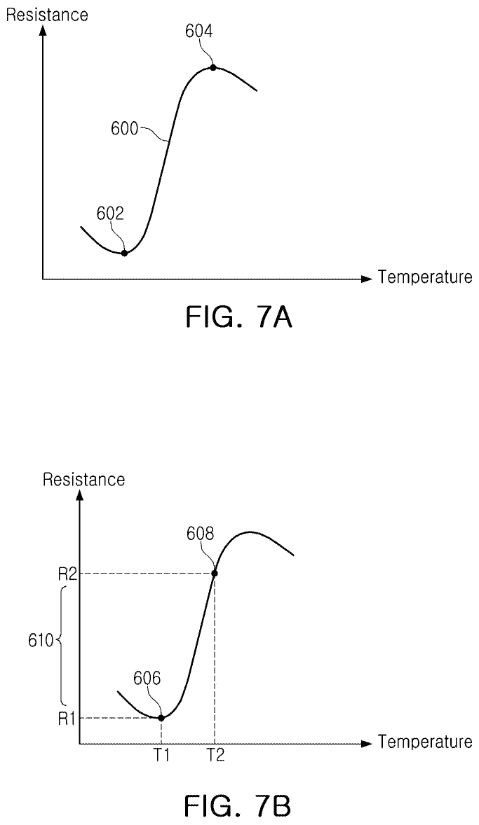

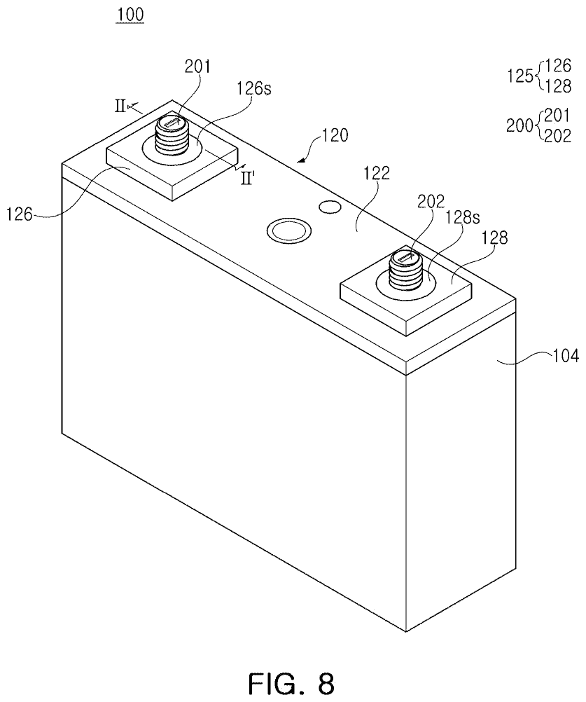

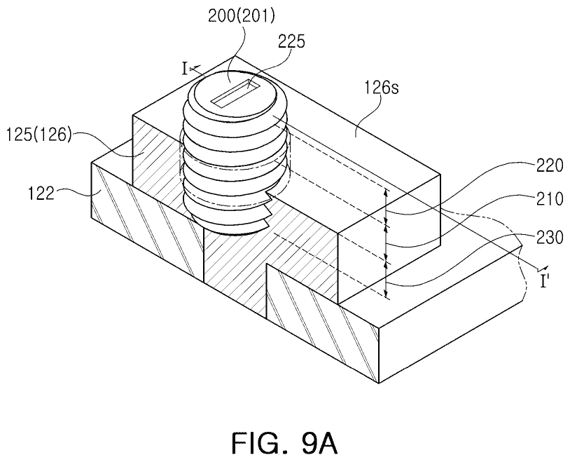

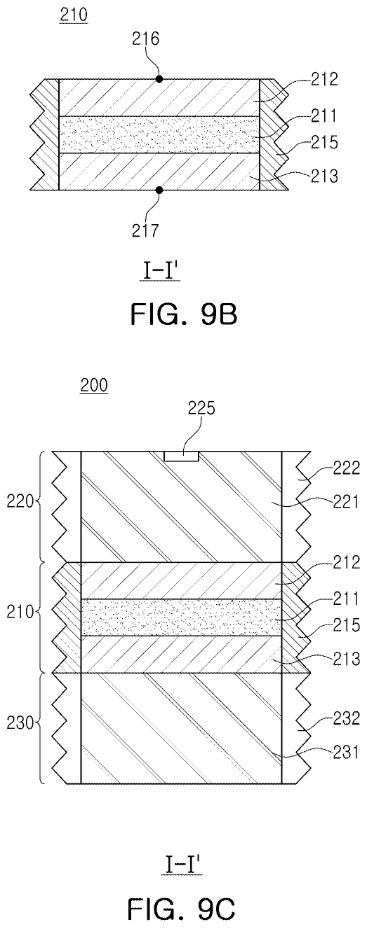

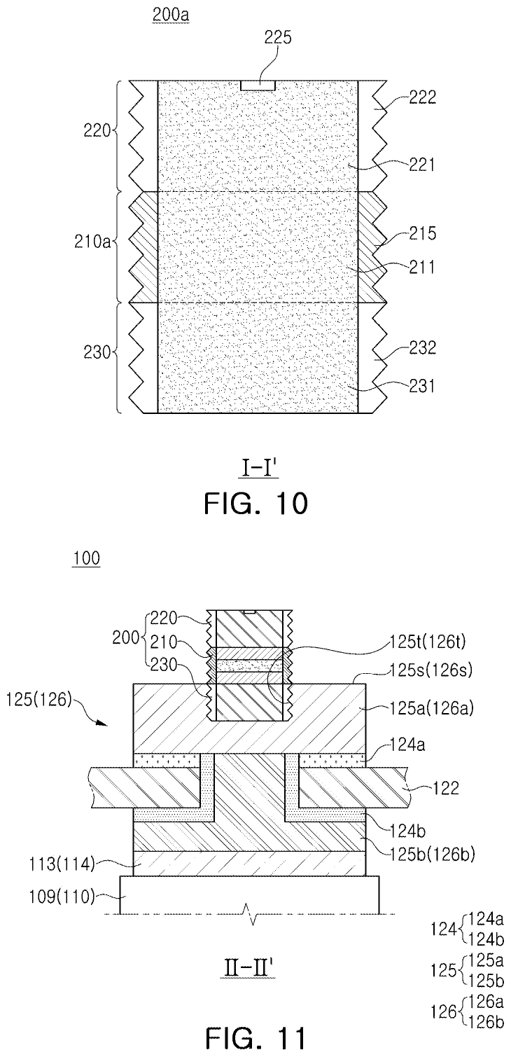

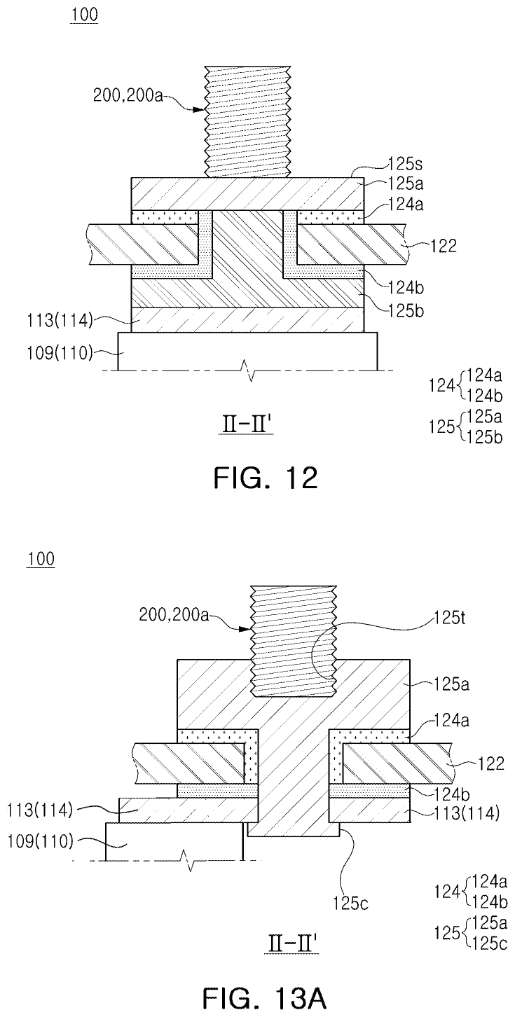

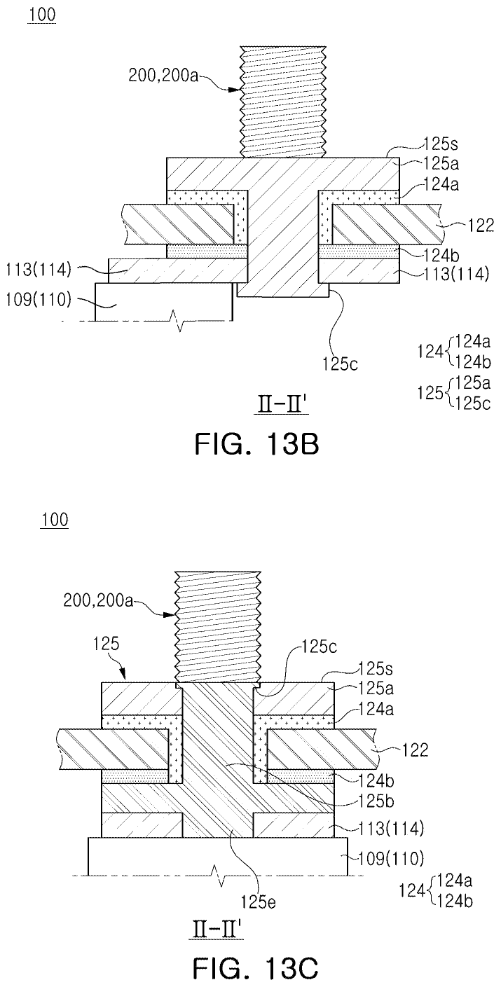

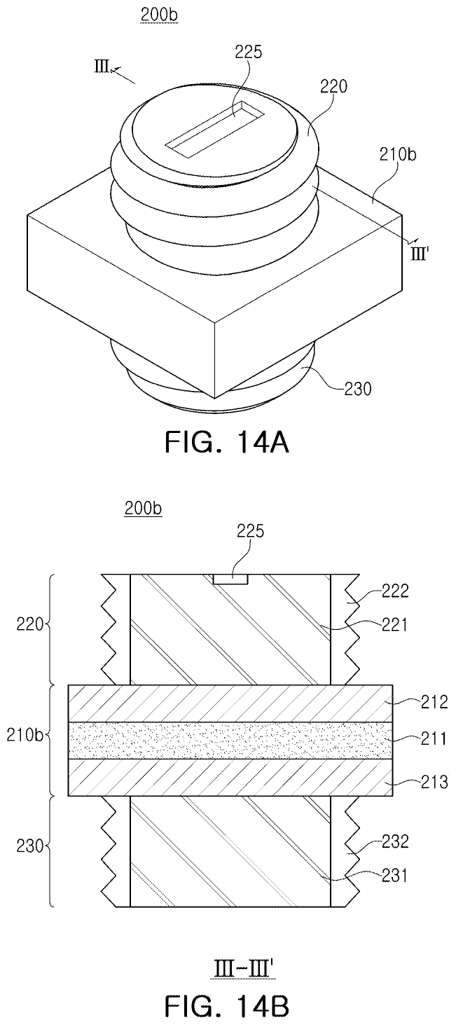

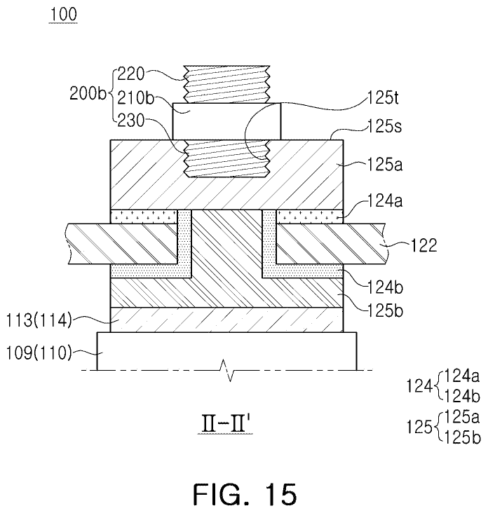

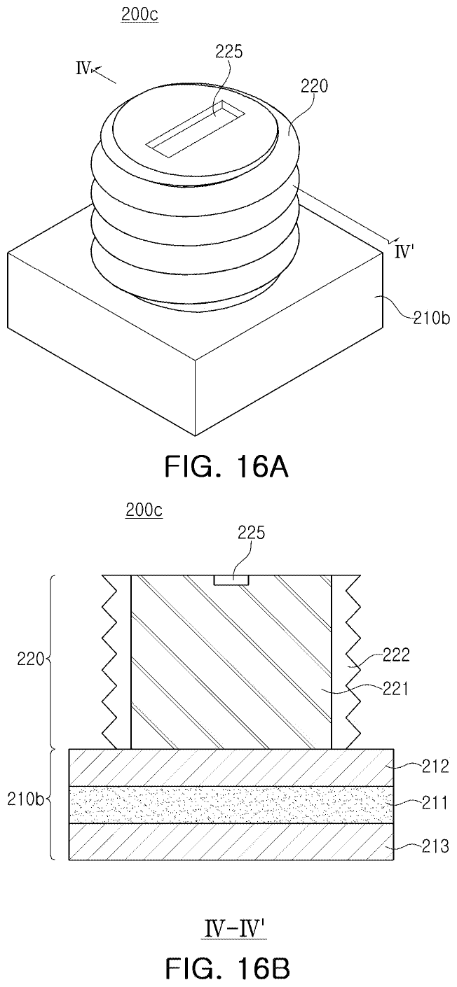

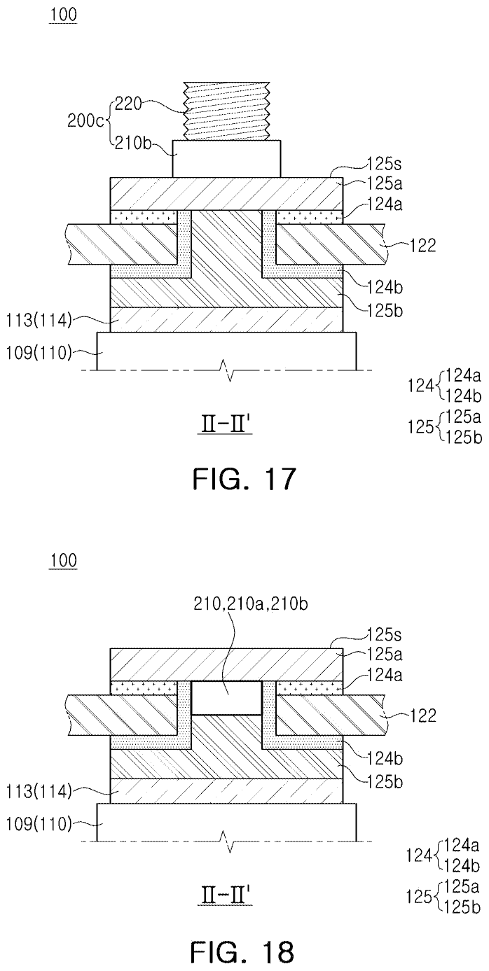

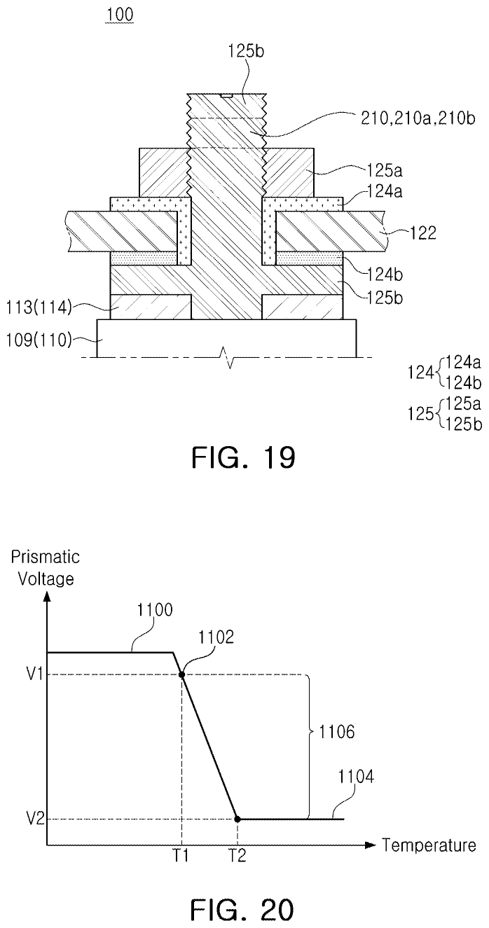

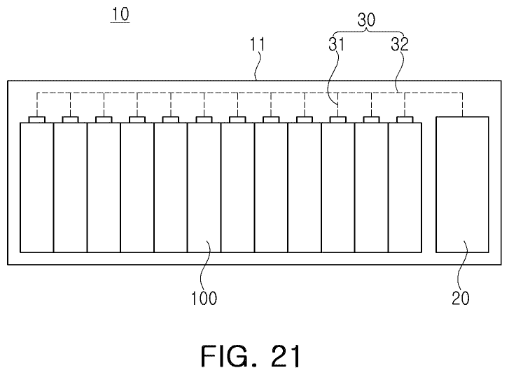

FIGS. 2A, 2B and 2C show a configuration and component functions of the top cap assembly 120. For example, FIG. 2A is an exploded perspective view of the top cap assembly 120 according to an embodiment of the present disclosure. FIG. 2B is a rear perspective view of the top cap assembly 120 according to an embodiment of the present disclosure. Description of the top cap assembly 120 of FIG. 1 may be applied to the top cap assembly 120 of FIGS. 2A, 2B and 2C.

The top cap assembly 120 serving as a cover for the prismatic battery cell 100 is a complex assembly including a plurality of welded components. Adhesives may be used instead of welding specific components.

The prismatic battery cell 100 may include the vent cover 130. The vent cover 130 provides overpressure alleviation when temperature and corresponding pressure increase in the prismatic battery cell 100. For example, the vent cover 130 may be activated in a preset pressure range. The vent cover 130 may be laser-welded to the top cap assembly 120.

The prismatic battery cell 100 may include the can 104. The can 104 may generally be formed of deep-drawn aluminum or stainless steel to prevent moisture from entering the cell, while providing diffusion resistance to organic solvents, such as liquid electrolytes. The most important reason the can 104 is typically formed of deep-drawn aluminum alloy or stainless steel is to reduce a welding point to improve the mechanical strength of the can 104. The electrolyte may be filled in the prismatic battery cell 100 through an injection port. After the electrolyte is filled, the injection port may be closed or sealed by an electrolyte cap 138. After electrolyte filling, the electrolyte cap 138 may be welded to the top cap assembly 120 or a locking ball (not shown) may be forced into the injection port. The cell may have an overcharge safety device 134 that may disconnect current flow when high internal pressure is reached in the prismatic battery cell 100. A rise in pressure is usually a result of high temperatures.

According to an embodiment, the cathode terminal 128 may be provided in plural. For example, the cathode terminal 128 may include a first cathode terminal 128a in which at least a portion is exposed to the outside of the battery cell 100 and a second cathode terminal 128b connected to a cathode foil (e.g., the cathode foil 112 of FIG. 1). The second cathode terminal 128b may be electrically connected to the first cathode terminal 128a. For example, a portion of the second cathode terminal 128b may contact the first cathode terminal 128a.

According to an embodiment, the anode terminal 126 may be provided in plural. For example, the anode terminal 126 may include a first anode terminal 126a in which at least a portion is exposed to the outside of the battery cell 100 and a second anode terminal 126b connected to an anode foil (e.g., the anode foil 110 of FIG. 1). The second anode terminal 126b may be electrically connected to the first anode terminal 126a. For example, a portion of the second anode terminal 126b may contact the first anode terminal 126a.

FIGS. 3A to 3F are a view illustrating an assembly process of a top cap assembly and an electrode assembly according to an embodiment. A battery cell manufacturing process 300 may include an assembly process of the top cap assembly 120 and the jelly roll 106.

Referring to FIG. 3A, a sealing tape 106a may be attached to the jelly roll 106. According to an embodiment, the sealing tape 106a can cover at least a portion of the jelly roll 106. According to an embodiment, the sealing tape 106a may seal a portion of the jelly roll 106.

Referring to FIG. 3B, the jelly roll 106 may be connected to the top cap assembly 120. For example, a connection component for connecting the jelly roll 106 and the top cap assembly 120 may be prepared. The top cap assembly 120 may be closely attached to the jelly roll 106 using the connection component. For example, the cathode terminal 128 of the top cap assembly 120 may be connected to the cathode foil 112 of the jelly roll 106, and the anode terminal 126 of the top cap assembly 120 may be connected to the jelly roll 106. The cathode terminal 128 may be welded to the cathode foil 112 and the anode terminal 126 may be welded (e.g., ultrasonic-welded) to the anode foil 110.

Referring to FIG. 3C, at least a portion of the cathode terminal 128 may be masked. For example, the cathode connector mask 118 may be disposed to cover a portion of the cathode terminal 128. The cathode connector mask 118 may protect the cathode terminal 128. Although not shown, the description of the masking of the cathode terminal 128 may be applied to the anode terminal 126 as well.

Referring to FIG. 3D and/or FIG. 3E, tape may be attached to at least a portion of the cathode terminal 128 and the anode terminal 126. For example, the battery cell 100 may include welding tapes 118a, 118b, 118c, and 118d attached to at least a portion of the cathode terminal 128, the anode terminal 126, the cathode foil 112, and/or the anode foil 110. According to an embodiment, the welding tapes 118a, 118b, 118c, 118d may be attached to at least a portion of a joint portion of the cathode terminal 128, the anode terminal 126, the cathode foil 112, and/or the anode foil 110. As the joint portion is covered with the welding tapes 118a, 118b, 118c, and 118d, the cathode terminal 128 and the anode terminal 126 may be protected.

Referring to FIG. 3F, the anode foil 110 connected to the anode terminal 126 may be folded. For example, when the top cap assembly 120 is disposed on the jelly roll 106, at least a portion of the anode foil 110 may be folded. Although not shown, when the top cap assembly 120 is placed on the jelly roll 106, the cathode foil 112 may also be folded.

FIGS. 4A to 4F are a view illustrating an assembly process of an electrode assembly, a jelly roll bag, and a can. A battery cell manufacturing process 400 may include an assembly process of the jelly roll 106, the jelly roll bag 108, and the can 104.

Referring to FIG. 4A, an insulator 136 may be installed on the battery cell 100. For example, the insulator 136 may be disposed between the can 104 and the cap assembly 120.

Referring to FIG. 4B, the jelly roll bag 108 may be prepared. The jelly roll bag 108 may cover at least a portion (e.g., a side surface) of the jelly roll 106. The jelly roll 106 may be surrounded by the jelly roll bag 108. The jelly roll bag 108 may protect the jelly roll 106 from external impact. In FIG. 4B, a structure in which the jelly roll bag 108 is disposed on two side surfaces of the jelly roll 106 is shown, but the structure of the jelly roll bag 108 is not limited thereto. For example, according to an embodiment, the jelly roll bag 108 may be formed to cover four side surfaces of the jelly roll 106.

Referring to FIG. 4C, an insulator 108a may be attached to the jelly roll 106. According to an embodiment, in a state in which the jelly roll bag 108 is unfolded, the insulator 108a may be attached to a lower portion of the jelly roll 106. The insulator 108a may be referred to as a lower insulator.

Referring to FIG. 4D, at least some of the components of the battery cell 100 may be taped. For example, the battery cell 100 may include the top cap assembly 120, the can 104, and/or at least one first tape 108b attached onto insulator 136, and/or a second tape 108c attached to a lower portion of the jelly roll bag 108 along a side portion of the insulator 136.

Referring to FIG. 4E, the jelly roll 106 may be inserted into the can 104. The jelly roll 106 and/or the jelly roll bag 108 may be inserted into the can 104.

According to an embodiment, the battery cell manufacturing process 400 may include a wetting process of the jelly roll 106. For example, the jelly roll 106 may be initially wetted by an electrolyte delivered through an electrolyte injection port. For example, partial vacuum may be formed in the prismatic battery cell 100, and a predetermined amount of electrolyte may be injected through the electrolyte injection port. The partial vacuum may improve the distribution and wetting of all layers within the jelly roll 106. Wetting of all layers within the jelly roll 106 may require a rolling or spinning protocol to enhance wetting.

According to an embodiment, the battery cell manufacturing process 400 may include a quality check process for the initial wetting process, such as checking a weight of the prismatic battery cell 100 immediately after charging. For example, a second electrolyte charging operation in which an electrolyte is charged to achieve a desired weight may be applied to the battery cell. According to an embodiment, the battery cell manufacturing process 400 may include a pre-formation process of charging the prismatic battery cell 100 and discharging gas.

Referring to FIG. 4F, the electrolyte injection port may be sealed. For example, the electrolyte cap 138 may be inserted into the electrolyte injection port.

FIG. 5A is a perspective view of an electrode assembly 106 including an electrode foil 109, according to one embodiment. FIG. 5B is a perspective view illustrating a connection between an electrode foil 109 and an electrode terminal 125 on a top cap assembly 120, according to one embodiment.

Referring to FIGS. 5A and 5B, a battery cell 100 may include jelly roll 106 and/or top cap assembly 120. The jelly roll 106 may be an example of an electrode assembly. Hereinafter, in this document and claims, the electrode assembly will be described using a jelly roll as an example, and is denoted by the same reference numeral “106.”

FIG. 5A is a perspective view of an electrode assembly 106 including an electrode foil 109. The electrode foil 109 may include an anode foil 110 and a cathode foil 112. A sealing tape 106a, covering at least a portion of the electrode assembly 106, may be affixed to an outer surface of the electrode assembly 106.

FIG. 5B is a perspective view illustrating a connection between the electrode foil 109 and the electrode terminal 125 on a top cap assembly 120. The top cap assembly 120 may include a cap plate 122 and the electrode terminal 125. The electrode terminal 125 may include an anode terminal 126 and a cathode terminal 128. The electrode terminal 125 may be connected to the electrode foil 109. For example, the cathode foil 112 may be electrically connected to the cathode terminal 128, and the anode foil 110 may be electrically connected to the anode terminal 126. The electrode terminal 125 may be connected to the electrode foil 109 through a current collector 113. The current collector 113 may include an anode connector 114 and a cathode connector 116. The anode foil 110 may be connected to the anode terminal 126 (for example, the second anode terminal 126b in FIG. 2C) through the anode connector 114. The anode foil 110 and the anode connector 114 may be coupled to each other by welding (for example, ultrasonic welding or the like). The cathode foil 112 may be connected to the cathode terminal 128 (for example, the second cathode terminal 128b in FIG. 2C) through the cathode connector 116. The cathode foil 112 and the cathode connector 116 may be coupled to each other by welding (for example, ultrasonic welding or the like).

FIG. 6 illustrates the effects of thermal runaway on a battery cell 100.

FIG. 6 illustrates a cross-section of a portion of a jelly roll 106 with layers. In a lower portion of FIG. 6, a temperature gradient from 20° C. to 80° C. is indicated by intervals between lines. In FIG. 6, a top layer may be an anode foil 110, having a temperature gradient from a normal operation range of 20° C. to 40° C. on the right and a destructive temperature higher than or equal to 60° C. seen in thermal runaway on the left. Below the anode foil 110, a protective layer 500 may be disposed between the anode foil 110 and an electrolyte 502. The electrolyte 502 may be generally a lithium salt in an organic solvent. The electrolyte 502 may be positioned between the anode foil 110 and a cathode foil 112. Lithium-ion batteries may operate in a narrow temperature range from 15° C. to 45° C. Above the temperature, the functional safety and stability of the prismatic battery cell 100 may be compromised. A separator 504 may be disposed in the electrolyte 502. As the prismatic battery cell 100 heats up beyond a stable operation range, the separator 504 may begin to break down and melt. Such a breakdown may cause an increase in temperature, which may cause the release of more energy through a chain reaction that decomposes the electrolyte 502 into flammable gases 506.

FIGS. 7A and 7B are graphs illustrating a detection region of a PTC fuse, according to one embodiment.

FIG. 7A illustrates a relationship between temperature and resistance in a positive temperature coefficient (PTC) material. The electrical resistance of the PTC material may increase in relation to temperature, as illustrated in the curve 600. The resistance of the PTC material may rapidly increase in a narrow temperature range from a lowest resistance point thereof 602 to a highest resistance point thereof 604. The material properties of the PTC material may change a temperature threshold at which resistance changes.

FIG. 7B illustrates an example of a resistance response of a PTC material to temperature. A normal operation state 608 may have a resistance of R1 at temperature T1. A critical region 608 may exist above a threshold temperature T2 that causes resistance of the PTC material to exceed R2 and disconnects a circuit. A detection region 610 in which resistance is greater than R1 and less than R2 may be used by a battery management system to detect a prismatic battery cell that are approaching the critical region 608 and take steps to mitigate potential thermal runaway.

FIG. 8 is a perspective view illustrating a structure in which a terminal connector 200 is coupled to an electrode terminal 125 of a battery cell, according to one embodiment.

A battery cell 100 may include a case 104 and a top cap assembly 120, and the top cap assembly 120 may include a cap plate 122 and the electrode terminal 125 exposed to the outside of the cap plate 122. The battery cell 100 may include the terminal connector 200 for electrically connecting the electrode terminal 125 to the outside of the battery cell 100. The terminal connector 200 may be manufactured in a state of being separated from the electrode terminal 125, and may be coupled to the electrode terminal 125, but may also be integrally formed with the electrode terminal 125. In addition, the terminal connector 200 may have a nut shape in addition to a bolt (screw) shape. An anode terminal connector 201 may be connected to an anode terminal 126, and a cathode terminal connector 202 may be connected to a cathode terminal 128.

The terminal connector 200 may include a threaded screw-type connector. A lower portion of the terminal connector 200 may be connected to the electrode terminal 125 through screw coupling. An upper (top) portion of the terminal connector 200 may be coupled to a nut-type external connector for electrical connection with an external circuit such as a bus bar or the like. An anode terminal screw stop 126s may be disposed on an upper surface of the anode terminal 126. The anode terminal screw stop 126s may set a position (height) at which the nut-type external connector is fixed. A non-conductive insulating member may be disposed between the anode terminal screw stop 126s and the upper surface of the anode terminal 126 such that the anode terminal 126 and the nut-type external connector are not directly electrically connected to each other. Similarly, a cathode terminal screw stop 128s may be disposed on an upper surface of the cathode terminal 128. The cathode terminal screw stop 128s may set a position (height) at which the nut-shaped external connector is fixed. A non-conductive insulating member may be disposed between the cathode terminal screw stop 128s and the upper surface of the cathode terminal 128 such that the cathode terminal 128 and the nut-type external connector are not directly electrically connected to each other. In an example embodiment, at least one of the anode terminal connector 201 and the cathode terminal connector 202 may be separated from the anode terminal 126 or the cathode terminal 128.

Alternatively, the terminal connector 200 may be affixed to the electrode terminal 125 through welding or the like. For example, the anode terminal connector 201 may be affixed to the anode terminal 126 through ultrasonic welding. Similarly, the cathode terminal connector 202 may be affixed to the cathode terminal 128 through ultrasonic welding.

FIG. 9A is a partially cut-away perspective view schematically illustrating a coupling portion between an electrode terminal 125 and a terminal connector 200 in FIG. 8. FIG. 9B is a cross-sectional view of a PTC fuse 210 taken along line I-I′ of FIG. 9A. FIG. 9C is a cross-sectional view of the terminal connector 200 taken along line I-I′ of FIG. 9A. FIG. 9A illustrates, as an example, a portion of the electrode terminals 125 in which an anode terminal 126 is coupled to an anode terminal connector 201, but the terminal connector 200 may also be coupled to a cathode terminal 128.

The PTC fuse 210 may block or limit current flow between the electrode terminal 125 and the outside at a set temperature or higher (near a critical temperature). The PTC fuse 210 may be connected to the electrode terminal 125 in series. The PTC fuse 210 may include a PTC material having resistance increasing as the temperature increases in a specific temperature range. The PTC fuse 210 may include a piece of polymeric material loaded with conductive particles such as copper, nickel, or carbon black. The piece of polymeric material may include a crystalline polymeric material. At room temperature, a polymer may be in a semi-crystalline state allowing the conductive particles to remain in contact with each other and conduct electricity from one end of the PTC fuse 210 to the other end of the PTC fuse 210. As current passes through the PTC fuse 210, power may be wasted and the temperature may increase. The PTC fuse 210 will be rated for a hold current, below which the PTC fuse 210 may remain in a low resistance state, such that a circuit may operate normally. Then, when the hold current is exceeded, the PTC fuse 210 may reach a trip current and the PTC fuse 210 may rapidly heat up, such that a state of the polymer may be changed from a semi-crystalline state to an amorphous state, increasing a space between the conductive particles to stop the operation of the circuit.

When charging and/or discharging of a battery cell is performed at a high temperature (for example, 60° C. or higher), the battery cell may overheat, causing the battery cell to expand or explode, or causing a fire. A battery cell according to the related art may include safety components such as transistors to prevent overcurrent due to overdischarge, overcharge, and short circuits. However, the battery cell according to the related art has a limitation in coping with a case in which the cause of an increase in internal temperature of the battery cell is not due to overcurrent. That is, the battery cell according to the related art may not effectively resolve issues caused by overheating of battery cells. However, in embodiments, the PTC fuse 210 may operate when the battery cell temperature increases, issues caused by overheating may be effectively resolved. In addition, even when an overcurrent occurs in the battery cell, an increase in temperature caused by heat generation may occur, and thus the PTC fuse 210 may block current flowing through the battery cell regardless of the cause of the increase in temperature of the battery cell. Accordingly, according to an embodiment, overheating may be stably coped with.

FIG. 9A schematically illustrates a state in which an anode terminal 126 and an anode terminal connector 201 are coupled to each other. An electrode terminal 125 may be installed to pass through the cap plate 122. A portion of the electrode terminal 125 may be exposed on an external surface of the cap plate 122. A terminal connector 200 may include a PTC fuse 210. The terminal connector 200 may include an outbound connection region 220 connected to an external circuit. The terminal connector 200 may include a terminal connection region 230 threadedly fixed to the electrode terminal 125. The terminal connector 200 may include a screw thread formed on at least a portion of a side surface thereof. An anode terminal screw stop 126s may be positioned at a boundary between a region of the PTC fuse 210 and the terminal connection region 230. When a nut-type external connector is coupled to the terminal connector 200, the anode terminal screw stop 126s may limit a position at which the nut-type external connector is coupled. The electrode terminal 125 may be in contact with the terminal connection region 230 and may not in contact with the outbound connection region 220. The electrode terminal 125 and the external circuit may be connected to each other through the PTC fuse 210. A tool fastening groove 225 may be formed on an upper surface of the terminal connector 220 such that the terminal connector 220 is threadedly coupled to or separated from the electrode terminal 125.

FIG. 9B illustrates a cross-section of a PTC fuse 210. The PTC fuse 210 may include a first portion 211 including a PTC material. The PTC material may have a property in which resistance increases as the temperature increases in a specific temperature range (for example, see FIGS. 7A and 7B). A temperature range in which resistance rapidly increases or current flow is blocked may vary depending on the properties of the PTC material. Therefore, the type or properties of the PTC material may be selected such that the PTC fuse 210 operates in a specific temperature range corresponding to thermal runaway of the battery cell 100.

The PTC fuse 210 may include a second portion 212 and a third portion 213 disposed on both sides of the first portion 211 with respect to a direction in which current flows. That is, the third portion 213, the first portion 211, and the second portion 212 may be sequentially connected to each other in series. The second portion 212 and the third portion 213 may have electrical conductivity. The second portion 212 may be disposed to oppose an outbound connection region 220, and the third portion 213 may be disposed to oppose an electrode terminal 125.

At least a portion of a side surface of the PTC fuse 210 may include a non-conductive layer 215. The non-conductive layer 215 may have a shape surrounding a side surface of the first portion 211. The non-conductive layer 215 may have a shape surrounding a side surface of the second portion 212 and a side surface of the third portion 213. The non-conductive layer 215 may be formed of plastic, polymer, resin, or another non-conductive material. The non-conductive layer 215 may force an electrical circuit to be completed through the first portion 211 of the PTC fuse 210. For example, current between the second portion 212 and the third portion 213 may flow through the first portion 211, but may not flow through the non-conductive layer 215. Accordingly, when the resistance of the PTC material of the first portion 211 increases or the current flow of the first portion 211 is blocked due to a temperature increase, current may not flow between the second portion 212 and the third portion 213. The non-conductive layer 215 may have a screw thread shape to enable screw coupling.

The second portion 212 of the PTC fuse 210 may be connected to the outbound connection region 220 through an outbound weld point 216. The third portion 213 of the PTC fuse 210 may be connected to a terminal connection region 230 through an electrode weld point 217.

FIG. 9C illustrates a cross-section of a terminal connector 200. The PTC fuse 210 may be integrally coupled to the terminal connector 200. The PTC fuse 210 may form at least a portion of the terminal connector 200.

The terminal connector 200 may include an outbound connection region 220 connecting the PTC fuse 210 and an external circuit to each other. The outbound connection region 220 may have electrical conductivity. The PTC fuse 210 and the outbound connection region 220 may be connected to each other in series. The outbound connection region 220 may include a body 221 including an electrically conductive material and a side surface 222 surrounding the body 221. The side surface 222 of the outbound connection region 220 may have electrical conductivity. The outbound connection region 220 may be exposed to the outside of an electrode terminal 125 to be coupled to an external connector. The side surface 222 of the outbound connection region 220 may have a screw thread such that the outbound connection region 220 is threadedly coupled to a nut-type external connector. However, depending on a shape or coupling structure of the external connector connected to the outbound connection region 220, the side surface 222 of the outbound connection region 220 may have non-conductivity or may have a smooth surface.

The terminal connector 200 may further include a terminal connection region 230 connecting the PTC fuse 210 and the electrode terminal 125 to each other. The terminal connection region 230 may have electrical conductivity. The terminal connection region 230, the PTC fuse 210, and the outbound connection region 220 may be sequentially connected to each other in series. The terminal connection region 230 may include a body 231 including an electrically conductive material and a side surface 232 surrounding the body 231. The side surface 232 of the terminal connection region 230 may have electrical conductivity. The terminal connection region 230 may be threadedly coupled or weldedly coupled to the electrode terminal 125. The side surface 232 of the terminal connection region 230 may have a screw thread such that the terminal connection region 230 is threadedly coupled to the electrode terminal 125. However, depending on a shape or coupling structure of the electrode terminal 125 connected to the terminal connection region 230, the side surface 232 of the terminal connection region 230 may have non-conductivity or may have a smooth surface. The terminal connection region 230 may be disposed to be recessed into the electrode terminal 125 (see FIG. 11) or may be disposed to be affixed to an external surface of the electrode terminal 125 (see FIG. 12). In FIG. 9C, the PTC fuse 210 is illustrated as having a second portion 212 and a third portion 213. However, the PTC fuse 210 may not have at least one of the second portion 212 and the third portion 213. FIG. 9C illustrates that the outbound connection region 220 and the terminal connection region 230 are coupled to both sides of the PTC fuse 210, respectively. However, the terminal connector 200 may not include at least one of the outbound connection region 220 and the terminal connection region 230 (see FIGS. 16A and 16B).

FIG. 10 is a cross-sectional view illustrating a modification of the terminal connector 200 illustrated in FIG. 9C.

A terminal connector 200a illustrated in FIG. 10 may include a PTC fuse 210a, an outbound connection region 220, and a terminal connection region 230. The PTC fuse 210a may include a first portion 211 including a PTC material and a non-conductive layer 215 surrounding a side surface of the first portion 211. The first portion 211 including the PTC material may be directly affixed to the outbound connection region 220 and the electrode connection region 230 using welding or the like.

The outbound connection region 220 may include a body 221 and a side surface 222 surrounding the body 221. The body 221 of the outbound connection region 220 may include a PTC material. The side surface 222 of the outbound connection region 220 may have electrical conductivity, and may include a PTC material. The body 221 and the side surface 222 of the outbound connection region 220 may be formed of the same material, but the disclosed technology is not limited thereto. The side surface 222 of the outbound connection region 220 may have a screw thread such that the outbound connection region 220 is threadedly coupled to a nut-type external connector.

The electrode connection region 230 may include a body 231 and a side surface 232 surrounding the body 231. The body 231 of the electrode connection region 230 may include a PTC material. The side surface 232 of the electrode connection region 230 may have electrical conductivity, and may include a PTC material. The body 231 and the side surface 232 of the electrode connection region 230 may be formed of the same material, but the disclosed technology is not limited thereto. The side surface 232 of the electrode connection region 230 may have a screw thread such that the electrode connection region 230 is threadedly coupled to a nut-type external connector.

FIG. 11 is a cross-sectional view taken along line II-II′ of FIG. 8, according to one embodiment.

FIG. 11 is a cross-sectional view illustrating a state in which a terminal connector 200 is connected to a battery cell 100, and internal components of the battery cell 100 are illustrated with reference to the battery cell illustrated in FIGS. 1 to 5B.

The battery cell 100 may include an electrode terminal 125 electrically connected to an electrode foil 109. The electrode terminal 125 may pass through a cap plate 122 to be disposed on the inside and outside of the case (104 in FIG. 1). For example, a portion of the electrode terminal 125 may be disposed on a lower portion of the cap plate 122 to oppose the electrode foil 109, and another portion of the electrode terminal 125 may be exposed to the outside of the cap plate 122. The electrode terminal 125 may have a divided structure so as to be disposed in a state of passing through the cap plate 122. For example, the electrode terminal 125 may include a first terminal body 125a having at least a portion disposed on the outside of the case 104 or the cap plate 122 and a second terminal body 125b having at least a portion disposed on the inside of the case 104 or the cap plate 122. The first terminal body 125a and the second terminal body 125b may be coupled to the cap plate 122 in a state of being separated from each other. The first terminal body 125a may be provided for electrical connection to the outside, and the second terminal body 125b may be provided for electrical connection to the electrode foil 109. The second terminal body 125b and the electrode foil 109 may be electrically connected to each other through a current collector 113. In this case, the current collector 113 may have one side coupled to the electrode foil 109 and the other side coupled to the electrode terminal 125.

An insulating member (top insulator) 124 may be disposed between the electrode terminal 125 and the cap plate 122 for electrical insulation. The insulating member 124 may include a first insulating member 124a insulating between an upper surface of the cap plate 122 and the electrode terminal 125, and a second insulating member 124b insulating between a lower surface of the cap plate 122 and the electrode terminal 125. However, when the cap plate 122 has a polarity structure, one of an anode terminal 126 and a cathode terminal 128 may not include at least one of the first insulating member 124a and the second insulating member 124b.

The terminal connector 200 may be coupled to the electrode terminal 125. The electrode terminal 125 may include a coupling groove 125t into which a terminal connection region 230 of the terminal connector 200 is inserted. An electrode terminal screw stop 125s may be disposed on an upper surface of the electrode terminal 125. A position (height) at which a nut-shaped external connector is fixed may be set by the electrode terminal screw stop 125s. The electrode terminal screw stop 125s may be positioned in a region of the PTC fuse 210 or at a boundary between the region of the PTC fuse 210 and the terminal connection region 230.

The terminal connector 200 may be coupled to the anode terminal 126. The anode terminal 126 may include a coupling groove 126t such that the terminal connector 200 is coupled in an inserted state. The anode terminal 126 may include a first anode terminal 126a at least partially exposed to the outside of the battery cell 100 and a second anode terminal 126b connected to an anode foil 110. The anode foil 110 and the second anode terminal 126b may be connected to each other by an anode connector 114. An anode terminal screw stop 126s may be disposed on an upper surface of the anode terminal 126. Although FIG. 11 illustrates the anode terminal 126 of the electrode terminal 125, a cross-sectional structure of FIG. 11 may also be applied to a cathode terminal 128.

FIG. 12 is a cross-sectional view of a modification of the battery cell illustrated in FIG. 11.

As compared to the battery cell illustrated in FIG. 11, the battery cell illustrated in FIG. 12 may have a structure in which terminal connectors 200 and 200a are affixed to an external surface of an electrode terminal 125. The terminal connectors 200 and 200a may be affixed to an upper surface 125s of the electrode terminal 125 by welding or the like.

FIGS. 13A, 13B, and 13C are cross-sectional views illustrating a modification of the battery cell illustrated in FIG. 12.

As illustrated in FIGS. 13A and 13B, an electrode terminal 125 may include a single terminal body. The electrode terminal 125 may include a first terminal body 125a passing through a cap plate 122 to be disposed on an upper portion and a lower portion of the cap plate 122. The electrode terminal 125 may be riveted to the lower portion of the cap plate 122. For example, the first terminal body 125a may be riveted in a state of passing through the cap plate 122 and a current collector 113. A deformed portion 125c formed by riveting may have a diameter greater than that of an opening formed in the current collector 113, and may be formed on a lower portion of the current collector 113. As illustrated in FIG. 13A, terminal connectors 200 and 200a may be connected to each other in a state in which portions thereof are recessed into the electrode terminal 125. Alternatively, as illustrated in FIG. 13B, lower surfaces of the terminal connectors 200 and 200a may be affixed to an upper surface 125s of the electrode terminal 125 by welding or the like.

In the battery cell illustrated in FIG. 13C, an example in which an electrode terminal 125 is riveted to the outside of a cap plate 122 is illustrated. The electrode terminal 125 may include a first terminal body 125a disposed on the outside of the cap plate 122, and a second terminal body 125b passing through the first terminal body 125a and the cap plate 122 to be disposed on an upper portion and a lower portion of the cap plate 122. The second terminal body 125b may include a protrusion 125e fittingly coupled to a current collector 113. The second terminal body 125b may be riveted to the upper portion of the cap plate 122. For example, the second terminal body 125b may be riveted in a state of passing through the cap plate 122 and the first terminal body 125a. A deformed portion 125c formed by riveting may have a diameter greater than that of an opening formed in the first terminal body 125a, and may be formed on an upper portion of the first terminal body 125a. Lower surfaces of the terminal connectors 200 and 200a may be affixed to an upper surface 125s of the electrode terminal 125 by welding or the like.

FIGS. 14A and 14B illustrate a modification of a terminal connector. FIG. 14A is a perspective view, and FIG. 14B is a cross-sectional view taken along line III-III′ of FIG. 14A.

A terminal connector 200b illustrated in FIGS. 14A and 14B may include a PTC fuse 210b, an outbound connection region 220 connected to an external circuit, and a terminal connection region 230 connected to an electrode terminal 125. The PTC fuse 210b may be disposed between the terminal connection region 230 and the outbound connection region 220. The terminal connector 200b illustrated in FIGS. 14A and 14B may be different from the terminal connector 200 illustrated in FIGS. 9A to 9C in terms of a shape and structure of the PTC fuse 210b. The PTC fuse 210b may have a diameter greater than a diameter of the outbound connection region 220 and a diameter of the terminal connection region 230. The PTC fuse 210b may have a shape protruding from a side surface of the terminal connection region 230.

Referring to FIG. 14B, the PTC fuse 210b may include a first portion 211 including a PTC material, a second portion 212 disposed on both sides of the first portion 211 with respect to a direction in which current flows, and a third portion 213. The second portion 212 and the third portion 213 may have electrical conductivity. The second portion 212 may be coupled to the outbound connection region 220 by welding or the like, and the third portion 213 may be coupled to the terminal connection region 230 by welding or the like.

FIG. 15 is a cross-sectional view illustrating a state in which the terminal connector 200b illustrated in FIG. 14A is installed.

Referring to FIG. 15, the terminal connection region 230 of the terminal connector 200b may be fittingly coupled or threadedly coupled to a coupling groove 125t of the electrode terminal 125. The PTC fuse 210b of the terminal connector 200b may have a shape protruding from a side surface of the terminal connection region 230. A protruding portion of the PTC fuse 210b may be in contact with an upper surface 125s of the electrode terminal 125, such that an area of the terminal connector 200b in contact with the electrode terminal 125 may increase, and the terminal connector 200b may transfer more heat from the electrode terminal 125.

FIGS. 16A and 16B illustrate another modification of a terminal connector. FIG. 16A is a perspective view and FIG. 16B is a cross-sectional view taken along line IV-IV′ of FIG. 16A.

The terminal connector 200c illustrated in FIGS. 16A and 16B may include a PTC fuse 210b and an outbound connection region 220 connected to an external circuit. A terminal connector 200c illustrated in FIGS. 16A and 16B may be different from the terminal connector 200b illustrated in FIGS. 14A and 14B in that a terminal connection region 230 is not included. The PTC fuse 210b and the outbound connection region 220 illustrated in FIGS. 16A and 16B may have a configuration the same as that in FIGS. 14A and 14B.

FIG. 17 is a cross-sectional view illustrating a state in which the terminal connector 200c illustrated in FIG. 16A is installed.

Referring to FIG. 17, a PTC fuse 210b of a terminal connector 200c may have a shape protruding from a side surface of an outbound connection region 220. A protruding portion of the PTC fuse 210b may be in contact with an upper surface 125s of an electrode terminal 125, such that an area of the terminal connector 200c in contact with the electrode terminal 125 may increase, and the terminal connector 200c may transfer more heat from the electrode terminal 125.

FIGS. 18 and 19 are cross-sectional views illustrating the arrangement of a PTC fuse, according to another embodiment.

PTC fuses 210, 210a, and 210b may form at least a portion of an electrode terminal 125 or may be integrally coupled to the electrode terminal 125. The PTC fuses 210, 210a, and 210b may be integrated with the electrode terminal 125. The PTC fuses 210, 210a, and 210b may be integrally coupled to at least one of an anode terminal 126 and a cathode terminal 128, or may be integrated with at least one of the anode terminal 126 and the cathode terminal 128.

As illustrated in FIG. 18, the electrode terminal 125 may include a first terminal body 125a and a second terminal body 125b. In this case, the PTC fuses 210, 210a, and 210b may be integrally coupled to at least one of the first terminal body 125a and the second terminal body 125b. Alternatively, the PTC fuses 210, 210a, and 210b may be disposed between the first terminal body 125a and the second terminal body 125b.

For example, at least a portion of the first terminal body 125a may be disposed on the outside of the case 104 or the outside of the cap plate 122. At least a portion of the second terminal body 125b may be disposed on the inside of the case 104 or the inside of the cap plate 122, and may electrically connect an electrode foil 109 and the first terminal body 125a to each other. In this case, as illustrated in FIG. 18, the PTC fuses 210, 210a, and 210b may be disposed between the first terminal body 125a and the second terminal body 125b.

In addition, as illustrated in FIG. 19, the PTC fuses 210, 210a and 210b may be integrally formed on the inside of the electrode terminal 125. For example, in the embodiment of FIG. 19, the electrode terminal 125 may include a terminal body 125b passing through the cap plate 122 to be disposed on the outside of the case (104 in FIG. 1). In this case, the PTC fuses 210, 210a, and 210b may be integrally coupled to the terminal body 125b.

In addition, a configuration in which the PTC fuses 210, 210a, and 210b are integrally coupled to the electrode terminal 125 or integrated with the electrode terminal 125 may be implemented in various forms.

FIG. 20 is a graph illustrating a change in output voltage of a battery cell 100 based on a change in temperature.

FIG. 20 illustrates a case in which a battery management system (BMS) monitors PTC fuses 210, 210a, and 210b. The battery management system may use an output voltage to infer an operating temperature of the battery cell 100 utilizing a PTC fuse 210. As illustrated in FIG. 8B, when the temperature of the battery cell 100 enters a detection region 610 of the PTC fuse 210, resistance may increase. A line 1100 in FIG. 20 illustrates an output voltage of the battery cell 100 in relation to temperature. An output voltage higher than or equal to a first voltage V1 may represent an operating temperature lower than or equal to the detection region 610. When the temperature enters the detection region 610 at a first temperature T1, the output voltage may begin to drop as the resistance of the PTC fuse 802 increases. The output voltage may reach a second voltage V2 when the PTC reaches a threshold temperature T2. It may be expected that the output voltage gradually decreases as the battery cell 100 is discharged. A rapid decrease, seen in a region 1106 between points 1102 and 1104, maybe interpreted by the battery management system as the PTC fuse 210 being triggered or operation in the detection region 610.

FIG. 21 is a schematic diagram of a battery device 10, according to one embodiment.

Referring to FIG. 21, the battery device 10 may include a plurality of battery cells 100, a housing 11 accommodating the plurality of battery cells 100, and a controller 20. As described with reference to FIGS. 1 to 20, the plurality of battery cells 100 may include a battery cell including PTC fuses 210, 210a and 210b. The PTC fuses 210, 210a, and 210b may be integrally formed with a terminal connector 200 or an electrode terminal 125. The PTC fuses 210, 210a, and 210b may include a PTC material, and may block or limit current flow between the electrode terminal 125 and the outside at a temperature higher than a set temperature.

The controller 20 may include a battery management system (BMS) or may be configured as a portion of the battery management system. The controller 20 may be connected to at least one of the plurality of battery cells 100 through a signal line 30. The signal line 30 may include a first line 31 connected to the plurality of battery cells and a second line 32 connected to the controller 20. The second line 32 may include a plurality of lines to sense output voltages of the plurality of battery cells. When an output voltage, sensed from at least one of the plurality of battery cells, rapidly decreases in comparison to a set reference, the controller 20 may control the operation of at least one of the battery cells. For example, in the graph of FIG. 20, a rapid decrease, seen in a region 1106 between points 1102 and 1104, may be interpreted by the controller 20 as the PTC fuse 210 being triggered or operation in the detection region (610 in FIG. 8B). Accordingly, the controller 20 may perform a series of controls for delaying or blocking the occurrence of thermal runaway in the plurality of battery cells 100 disposed in the battery device 10. For example, the controller 20 may block or limit the use of a battery cell having increased temperature and at least one battery cell adjacent to the battery cell, among the plurality of battery cells disposed in the battery device 10. In addition, the controller 20 may block or limit the operation of all of the plurality of battery cells disposed in the battery device 10.

Functions performed in a process and method may be implemented in a different order. In addition, outlined steps and operations may be only provided as examples, and some of the steps and operations may be optional, combined into fewer steps and operations, or expanded into additional steps and operations without detracting from the essence of the disclosed embodiments.

Only specific examples of implementations of certain embodiments are described. Variations, improvements and enhancements of the disclosed embodiments and other embodiments may be made based on the disclosure of this patent document.

In addition, the embodiment has been described using a prismatic battery cell as an example, but the embodiment may be applied to a cylindrical battery cell or a coin-type battery cell.

What is claimed is:

1. A battery cell comprising:
an electrode assembly including an electrode foil;
an electrode terminal electrically connected to the electrode foil; and
a positive temperature coefficient (PTC) fuse coupled to the electrode terminal, the PTC fuse including a PTC material,
wherein the PTC fuse blocks or limits current flow between the electrode terminal and the outside at a set temperature or higher.

2. The battery cell of claim 1, wherein the PTC fuse includes a first portion including the PTC material, the first portion electrically connected to the electrode terminal.

3. The battery cell of claim 2, wherein
the PTC fuse further includes a second portion and a third portion respectively disposed on both sides of the first portion, and
the second portion and the third portion have electrical conductivity.

4. The battery cell of claim 2, wherein the PTC fuse includes a non-conductive layer surrounding a side surface of the first portion.

5. The battery cell of claim 1, further comprising:
a terminal connector coupled to the electrode terminal to supply current from the electrode terminal to the outside,
wherein the PTC fuse is integrally coupled to the terminal connector.

6. The battery cell of claim 5, wherein
the terminal connector includes an outbound connection region connecting the PTC fuse and an external circuit to each other, and
the outbound connection region has electrical conductivity.

7. The battery cell of claim 6, wherein the outbound connection region is exposed to the outside of the electrode terminal.

8. The battery cell of claim 6, wherein the PTC fuse has a diameter greater than that of the outbound connection region.

9. The battery cell of claim 6, wherein
the terminal connector further includes a terminal connection region connecting the PTC fuse and the electrode terminal to each other, and
the terminal connection region has electrical conductivity.

10. The battery cell of claim 9, wherein the terminal connection region is disposed to be recessed into the electrode terminal or disposed to be affixed to an external surface of the electrode terminal.

11. The battery cell of claim 9, wherein the terminal connection region is threadedly coupled or weldedly coupled to the electrode terminal.

12. The battery cell of claim 5, wherein the terminal connector includes a screw thread formed on at least a portion of a side surface thereof.

13. The battery cell of claim 9, wherein at least one of the outbound connection region and the terminal connection region includes a PTC material.

14. The battery cell of claim 1, wherein the PTC fuse is integrally coupled to the electrode terminal.

15. The battery cell of claim 14, further comprising:
a case accommodating the electrode assembly; and
a cap plate covering the case,
wherein the electrode terminal passes through the cap plate to be disposed on the inside and outside of the case.

16. The battery cell of claim 15, wherein
the electrode terminal includes a first terminal body having at least a portion disposed on the outside of the case, and a second terminal body having at least a portion disposed on the inside of the case, the second terminal body electrically connecting the electrode foil and the first terminal body to each other, and
the PTC fuse is integrally coupled to at least one of the first terminal body and the second terminal body, or is disposed between the first terminal body and the second terminal body.

17. The battery cell of claim 15, wherein
the electrode terminal includes a terminal body passing through the cap plate to be disposed on the outside of the case, and
the PTC fuse is integrally coupled to the terminal body.

18. The battery cell of claim 1, wherein the electrode terminal and the electrode foil are connected to each other by a current collector.

19. The battery cell of claim 1, wherein
the electrode terminal includes an anode terminal and a cathode terminal, and
the PTC fuse is disposed on at least one of the anode terminal and the cathode terminal.

20. A battery device comprising
a plurality of battery cells;
a housing accommodating the plurality of battery cells; and
a controller connected to at least one of the plurality of battery cells to control at least one of the plurality of battery cells,
wherein the plurality of battery cells include an electrode assembly including an electrode foil, an electrode terminal electrically connected to the electrode foil, and a positive temperature coefficient (PTC) fuse coupled to the electrode terminal, the PTC fuse including a PTC material,
the PTC fuse blocks or limits current flow between the electrode terminal and the outside at a set temperature or higher, and
the controller controls operation of at least one of the battery cells, when an output voltage, sensed from at least one of the plurality of battery cells, rapidly decreases in comparison to a set reference.
